(19) United States
(12) Patent Application Publication
(10) Pub. No.: US 2009/0088216 A1
(43) Pub. Date: Apr. 2, 2009

(54) User attachable keypad

(76) Inventors: Bruno Pichler, Vohringen (DE); Victor Burger, Ulm (DE); Ulrich Buschmann, Rammingen (DE); Lutz Abe, Erbach (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/571,964

(22) PCT Filed: Sep. 16, 2003
(86) PCT No.: PCT/EP2004/010281

§ 371 Date: Nov. 10, 2008

(51) Int. Cl. H04M 1/00; H04M 1/23; H04M 1/247

(52) U.S. Cl. 455/566; 455/575.1; 345/168

(57) ABSTRACT

A wireless communication terminal with a conventional keypad can be provided with a user exchangeable keypad. The wireless communication terminal and user exchangeable cover interface electrically, mechanically or via RF. The user exchangeable keypad can be part of a user exchangeable cover or part of a casing for receiving the wireless terminal. The user exchangeable keypad may have a reduced or adapted set of keys for e.g. facilitating the use of the terminal under special conditions or for visually impaired users. The user exchangeable keypad may be provided with identification means that allow the wireless terminal to identify the user exchangeable keypad and change its setting accordingly by e.g. increasing the font of the text on the display of the wireless terminal.

The present invention relates to a keypad for user attachment to a mobile communication terminal such as a mobile phone, in particular to user attachable keypads that are part of a user attachable cover or part of a casing for receiving a mobile communication terminal.

### BACKGROUND ART

The trend in mobile phones is generally towards smaller phones that have a keypad with minute keys and that use small fonts on the display. Elderly people and other users with impaired vision cannot use these phones comfortably. In other circumstances, e.g. while jogging it may also be advantageous for users with good vision to have larger keys and fonts available.

### DISCLOSURE OF THE INVENTION

Against this background, it is an object of the present invention to provide means for easily adapting a mobile communication terminal to different requirements.

This object is achieved in accordance with claim 1 by providing an assembly comprising a mobile communication terminal with a keypad, and a user attachable keypad for releasable attachment to the mobile communication terminal, an interface between the mobile communication terminal and the user attachable keypad that establishes a connection between the mobile communication terminal and the keys of the removable keypad when the removable keypad is attached to the phone.

By providing an assembly of a user attachable keypad and a mobile communication terminal it becomes possible to provide dedicated keypads suited for particular needs, thus increasing the flexibility of use of the mobile communication terminal.

The user removable keypad can be part of a releasable cover that is preferably provided with a window for allowing a display of the mobile communication terminal to be viewed. Users are already familiar with exchangeable covers, in which the keypad of the phone is integrated in the exchangeable cover. Here, there is provided a cover with a keypad that does not replace the keypad of the phone but is added to the phone.

The user attachable keypad or the cover can be placed over the front side of the phone thus covering the normal keypad of the phone and the user attachable keypad being superimposed on the keypad.

Alternatively, the cover can replace the rear cover of a phone with an exchangeable rear cover, and include a user attachable keypad. In case of a swivel phone the user attachable keypad can be used in combination with the in-build display of the phone by swiveling the upper part of the phone so that the display and the user attachable display are on the same side of the phone. In case of a phone with a one part housing, the cover may include both a display and a user attachable keypad. In this case a phone provided with such a cover will have a complete user interface on both sides of the phone, one of them being the build in phone interface and the other being a dedicated user interface that fulfills certain needs.

The user removable keypad can alternatively be part of a case in which the mobile communication terminal is received. The case is preferably provided with a window for allowing the display of the mobile communication terminal to be viewed. The case may further to the user attachable keypad comprise other features in connection with the particular needs that the casing is designed for, e.g. a clip for attachment to the steering rod of a bicycle, car dashboard, etc. The casing can be designed to have an ergonomically correct grip and corresponding keypad for persons with motion impairment, tremor, etc, like the impairments cause by e.g. Parkinson's disease

The interface between the user attachable keypad and the mobile communication terminal can be mechanical.

The keys of the removable keypad may act on the keys of the mobile communication terminal.

The user attachable keypad can be provided with one or more projections that press down permanently one or more keys of the keypad of the mobile communication terminal when the user attachable keypad is attached to the mobile communication terminal. Thus, the mobile communication terminal may identify the type of keypad that is attached.

The interface can be created by an electrical connector, that may include a plurality of connector pins. One of the connector pins can be operated for sensing a resistor value included in the identification means.

The user attachable keypad may comprise electronic identification means. The mobile communication terminal may identify the user attachable keypad by detecting the identification means, and change the settings of the mobile communication terminal in dependence of the type of the identified user attachable keypad. Thus the settings of the phone are automatically adjusted to the user attachable keypad concerned. The user can thus click the keypad on and is ready to use it.

The user exchangeable keypad may comprise one or more integrated circuits or microcontrollers, whereby the identification means and the electric circuitry are preferably incorporated in the one or more integrated circuits or microcontrollers.

The user releasable cover can be attached to the mobile communication terminal by a snap fit connection.

The user exchangeable keypad may comprise a reduced number of keys relative to the keypad of mobile communication terminal. Such a user attachable keypad may comprise no more than an on-hook key, an off-hook key and an emergency call key, these keys preferably being relatively large keys compared to the keys of the mobile communication terminal. Alternatively, the user exchangeable keypad comprises no more than an on-hook key, an off-hook key and an emergency call key, these keys preferably being relatively large keys compared to the keys of the mobile communication terminal. The user exchangeable keypad may also comprise no more than an on-hook key, an off-hook key, and ten numeric keys, eventually together with two symbol keys.

The casing can be formed by two hinged shells. Alternatively, the casing can be formed by two shells that are connected to one another or to the mobile communication terminal by a snap fit.

The mobile communication terminal may increase the font size for text to be displayed on the display when the user attachable keypad is identified.

The mobile communication terminal may comprise a speaker, and the characteristics of the signal delivered to the speaker are adjusted by the mobile communication terminal in accordance with the type of keypad identified, in particular if the keypad is part of a case, said signal characteristics preferably comprising loudness and equalizing.

The user attachable keypad may comprise a press-to-talk key. Thus, the mobile phone can be used in a walky-talky like manner.

The casing may comprise an extra battery.

The mobile communication terminal may comprise groups of settings in the form of profiles. In this case the mobile communication terminal may change to another active profile in dependence of the type of user attachable keypad identified.

The keys of the user attachable keypad may be illuminated and are preferably arranged in hand optimized positions.

The user attachable keypad may comprise memory means with settings for the mobile communication terminal stored thereon.

It is another object of the present invention to provide a keypad for user attachment to a mobile communication terminal, the mobile communication terminal has a keypad and the user attachable keypad comprises means for creating an interface with the mobile communication terminal when the user attachable keypad is attached to the mobile communication terminal.

By providing a user attachable keypad for a mobile communication terminal it becomes possible to provide dedicated keypads suited for particular needs, thus increasing the flexibility of use of the mobile communication terminal.

It is another object of the present invention to provide a mobile communication terminal comprising a keypad and means for adjusting settings of the mobile communication terminal when a user releasable keypad is attached to the mobile communication terminal.

By providing a mobile communication terminal with means for adjusting settings when an attachable keypad is attached it becomes possible to change the characteristics of the mobile communication terminal instantly.

Further objects, features, advantages and properties of the mobile communication terminal, the user attachable keypad and the assembly thereof will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 illustrates a preferred embodiment of a mobile terminal according to the invention,

FIG. 2 shows a block diagram of the mobile terminal of the embodiment of FIG. 1,

FIGS. 3, 4, and 5 are front views of a preferred embodiment of cases including different user attachable keypads according to the invention,

FIG. 6. is a side view of an case shown in FIGS. 4,5 and 6 and a mobile phone to be inserted therein,

FIG. 7 is a cross-sectional view through the case shown in FIGS. 4,5 and 6,

FIG. 8 is a cross-sectional view through a case that holds an additional battery,

FIG. 9 is a further illustration of the use of the case according to FIG. 3,

FIGS. 10 and 11 show in detail the construction of a four-way navigation key in a user a attachable keypad,

FIG. 12 shows in detail the construction of a two-way scroll key in a user a attachable keypad,

FIG. 12a shows in detail the construction of an emergency call key in a user a attachable keypad,

FIG. 13 shows a user attachable keypad that is superimposed on the normal keypad,

FIG. 14 shows a user attachable keypad that is attached to the back of a mobile terminal,

FIG. 15 illustrates the operation of attaching a user attachable keypad with a snap fit connection to a mobile phone,

FIG. 16 shows the rear side of the user attachable keypad of FIG. 15,

FIG. 17 shows a user attachable keypad that is integrated in a rear cover that can be attached to a mobile phone, and

FIG. 18 shows another preferred embodiment of the invention where the user attachable keypad is integrated in a softcase.

### DETAILED DESCRIPTION

In the following detailed description, a mobile communication terminal according to the invention in the form of a hand portable phone, preferably a cellular/mobile phone, will be described by the preferred embodiments. The invention can however also be carried out with any other mobile terminal having a keypad.

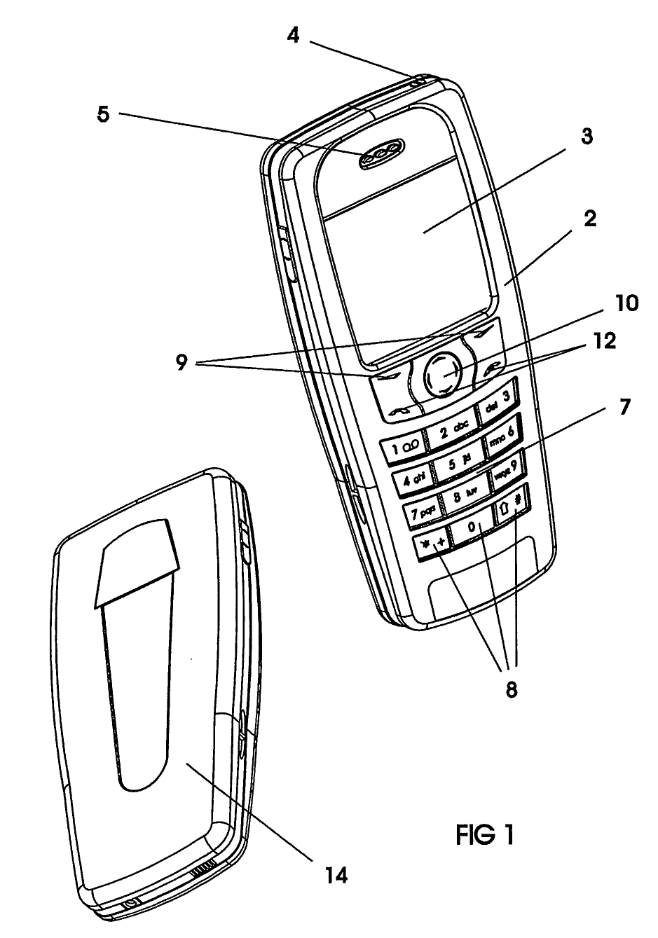

FIG. 1 shows a mobile phone according to the invention. The phone 1 comprises a user interface having a keypad 2, a display 3, an on/off button 4, a speaker 5 (only the openings are shown), and a microphone 6 (only the opening is shown). The phone 1 according to the preferred embodiment is adapted for communication via a cellular network, such as the GSM 900/1800 MHz network.

The keypad 2 has a first group 7 of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two soft-keys 9, two call handling keys 12, and an arrow key 10. The function of the soft-keys depends on the state of the phone and navigation in the menu can be performed by using the navigation-key. The present function of the softkeys 9 is shown in separate fields (soft labels) in the display 3, just above keys 9. The two call handling keys 12 are used for establishing a call or a conference call, terminating a call or rejecting an incoming call. This key layout is characteristic for e.g. the Nokia 6610™ phone.

The arrow key 10 is a four-way key which can be used for cursor movement and scrolling and is placed centrally on the front surface of the phone between the display 3 and the group of alphanumeric keys 7. A releasable rear cover 14 the battery pack in the back of the phone that supplies electrical power for the electronic components of the mobile phone.

The phone has a flat display 3 that is typically made of a LCD with optional back lighting, such as a TFT matrix capable of displaying color images.

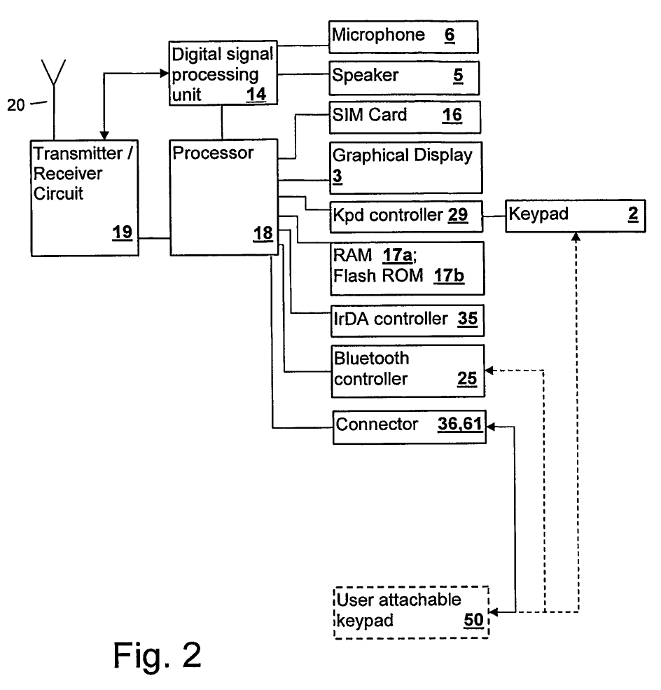

FIG. 2 schematically shows the most important parts of a preferred embodiment of the phone, in the form of a block diagram. A processor 18 controls the communication with the cellular network via the transmitter/receiver circuit 19 and an internal antenna 20. A microphone 6 transforms the user's speech into analogue signals, the analogue signals formed thereby are A/D converted in an A/D converter (not shown) before the speech is encoded in a digital signal processing unit 14 (DSP). The encoded speech signal is transferred to the processor 18, which i.e. supports the GSM terminal software. The processor 18 also forms the interface to the peripheral units of the apparatus, including a RAM memory 17a and a Flash ROM memory 17b, a SIM card 16, the display 3, the IrDA controller 35, the Bluetooth controller 25, the serial port 36,61 and the keypad controller 29 and keypad 2 (as well as data, power supply, etc.). The digital signal-processing unit 14 speech-decodes the signal, which is transferred from the processor 18 to the earpiece 5 via a D/A converter (not shown). The processor can be connected to a user attachable keypad 50 via a connector 36, 61, or via the Bluetooth controller 25.

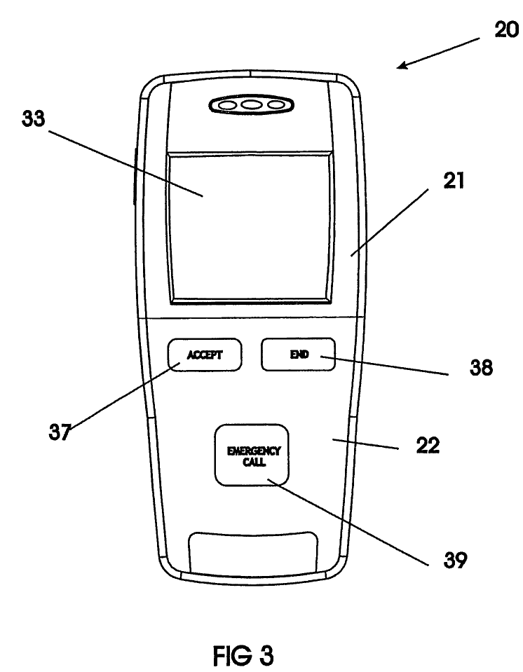

FIGS. 3. and 9. a illustrate a first preferred embodiment of a casing 20 for receiving a mobile phone. The casing is divided in an upper part 21 and a lower part 22 with a straight parting line in the middle of the longitudinal extension of the casing. The edges of the case parts 21,22 are provided with continuous EPDM neoprene gaskets (not shown) to render the casing watertight when closed. This casing is e.g. suitable for use for elderly people whose main need is a terminal that can be used to call for help. With other key arrangements the casing can also be used for other uses, e.g. dedicated sports applications. A mountaineering version could thus e.g. have an additional button (not shown) for operating an altimeter in the phone.

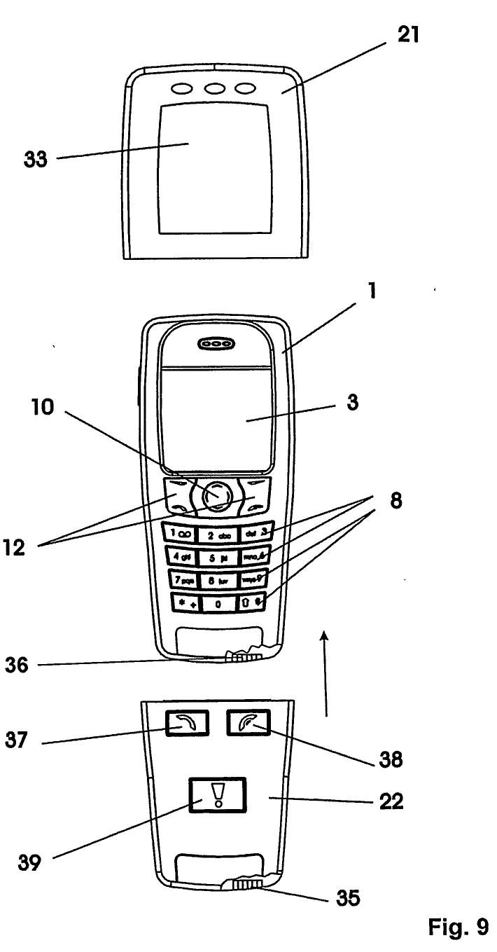

The upper and lower part 21,22 are assembled by sliding the upper part 21 over the top of the phone 1 in the direction of the arrow 31 in FIG. 9 and sliding the lower part 22 over the bottom of the phone 1 in the direction of the arrow 32 in FIG. 9 until the two parts abut and a snap fit connection is established.

The upper casing part 21 is provided with a window 33 allowing the display 3 of the mobile phone 1 to be viewed. The upper part 21 is also provided with openings for allowing the sound of the loudspeaker 5 of the phone 1 to leave the casing. A plurality of snap fit recesses (not shown) is provided on the inner side of the upper part 21.

The lower part 22 is equipped with corresponding projections (not shown) on its inner side. The snap fit recesses and projections does not need to be with the recesses in the upper part and the projection in the lower part, the arrangement can of course be reversed. The lower part 22 comprises an opening to allow sound to enter the casing to be picked up by the microphone 6.

An electrical connector 35 is arranged at the bottom of the lower part 22. This connector engages a complementary connector 36 at the bottom of the phone 1 when is placed in the lower part 22. An electrical connector interface is known from e.g. U.S. Ser. No. 10/085,010 hereby incorporated by reference. An electronic case identification embedded in lower part 22, in the form of a conventional or an integrated electric circuit is connected to the connector 35. Upon engagement of the contacts 35 and 36 the phone recognizes the type of casing and adjust its settings accordingly to match the keys on the casing and the information on the display, e.g. the softlabels of the softkeys 12 will not be displayed.

The lower part 22 is further provided with three large keys: a call answering key 37 “accept”, a call end/reject key 38 “end” and a call key 39 “emergency call”. The keys 37,38 and 39 act directly on the keys of the keypad 2 of the phone 1. The phone has been programmed to change profile in accordance with the casing that is identified via the contacts 35,36, thus changing the setting to correspond to the functions of the keys on the casing. A fixed number of e.g. an emergency call centre, is automatically assigned to the call key 39. The equalizer and volume settings of the loudspeaker may also be adjusted to the operation in a casing. Further the display setting may be changed to use large fonts that can be read without the need for using reading glasses.

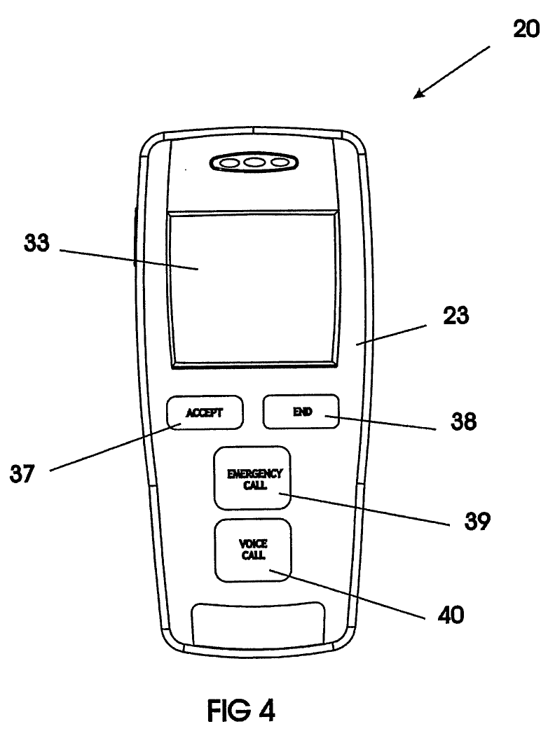

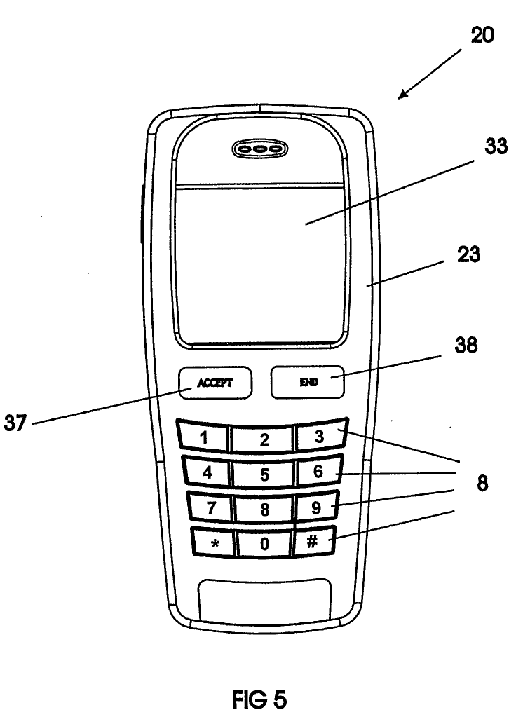

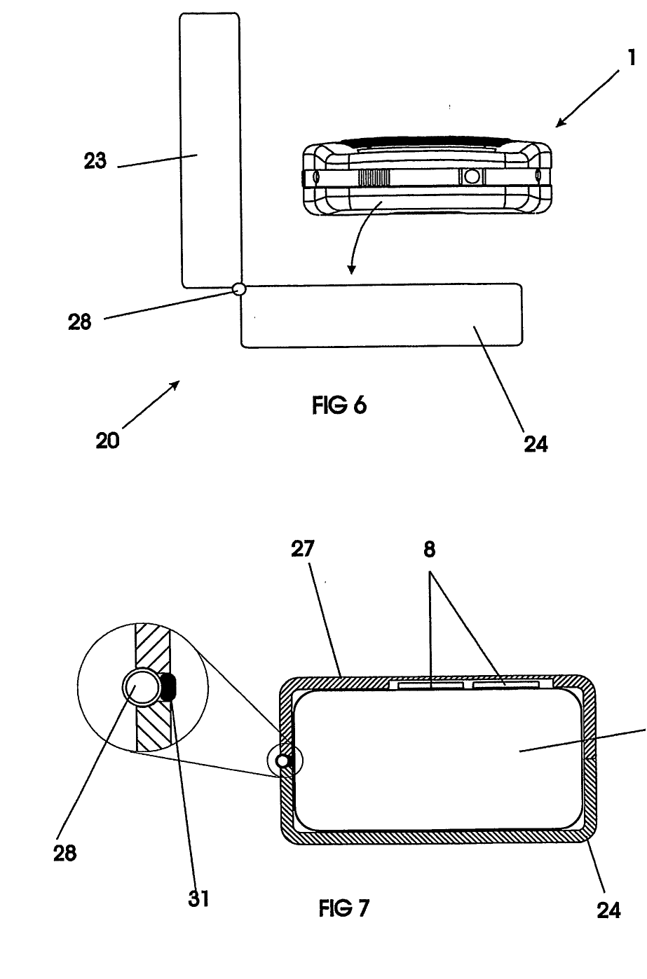

FIGS. 4. to 8. a illustrate a second preferred embodiment of a casing 20 for receiving a mobile phone. The casing is divided in an top part 23 and a bottom part 24 with a straight parting line in the middle of the height of the casing 20. The edges of the case halves are provided with continuous EPDM neoprene gaskets 31 to render the casing watertight when closed. The top part 23 and the bottom part 24 are connected by a hinge 28 that allows the case to be opened and closed. The two casing part may be provided with snap fit lock on the edges of the casing parts diagrammatically opposite to the hinge 28. Other locking means may also be used. The opening an closing movement of the top part relatively to the bottom part is preferably spring biased with a neutral middle position and an urge to the closing and to the opening direction to the opposite sides of the middle position. This casing is e.g. suitable for use for elderly people whose main need is a terminal that can be used to call for help, other applications can however be arranged in accordance with special needs. A gaming application could e.g. comprise a joystick (not shown) on the casing.

The top part 23 is provided with a window 33 allowing the display 3 of the mobile phone 1 to be viewed. The top part 23 is also provided with openings for allowing the sound of the loudspeaker 5 of the phone 1 to leave the casing. The top part 23 is further provided with four large keys: a call answering key 37 “accept”, a call end/reject key 38 “end”, a call key 39 “emergency call” and a “voice tag” key 40. The keys 37,38,39 and 40 act directly on the keys of the keypad 2 of the phone 1. The top part 23 has internal protrusions 27 that press continuously one or more keys of the keypad 2 of the phone 1. The phone 1 has been programmed to change profile in accordance with the key or key combination that is permanently depressed, thus changing the settings to correspond to the functions of the keys on the casing. A fixed number of e.g. an emergency call centre, is assigned to the call key 39. Further the display settings may be changed to use large fonts that can be read without the need for using reading glasses, hide or change the softkey labels and adapt the overall displayed information to the type of casing. The “voice tag” key 40 is used to save short spoken texts, that can be used to control other functions of the phone for which no key is available.

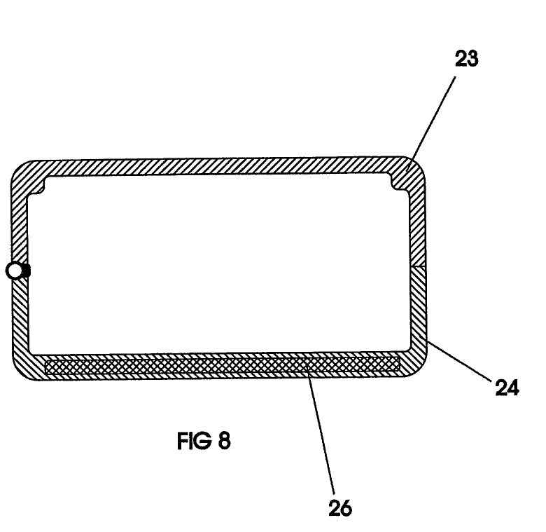

FIG. 8 shows a variation of the second preferred embodiment in which the bottom casing part 24 comprises an enclosure that can be used to add additional equipment. In the illustrated casing an extra battery 26 is included. In this variation the casing is also provided with an electrical connector that engages a counterpart on the phone (not shown). The enclosure can though comprise other equipment, e.g. a voice recognition system, a GPS location system, extra memory, an additional processor or can simply be a storage space for makeup, papers, keys, etc. The enclosure can be formed as a slot provided with electrical connectors, so that extra batteries, GPS receivers, digital cameras, text interpreters for audio output, etc can simply be slid into the slot in the casing. A part of the add-on equipment such as antennas and camera lenses may protrude from the slot. The casing can be provided with its own microphone and loudspeaker. The microphone and the loudspeaker may advantageously be suited for hands-free operation, thus facilitating the use of the phone while driving, jogging or other sportive activities where it is not practical to hold the phone on the ear. Voice control is particularly advantageous in connection with hands free operation.

The casing parts can be provided with lighting elements. These may serve to lit the keys, and may support ringing tones by light flashes. There may be provided a large plurality of LEDs to create more elaborated light effects. The lighting elements may also comprise electroluminescent sheets and light guides.

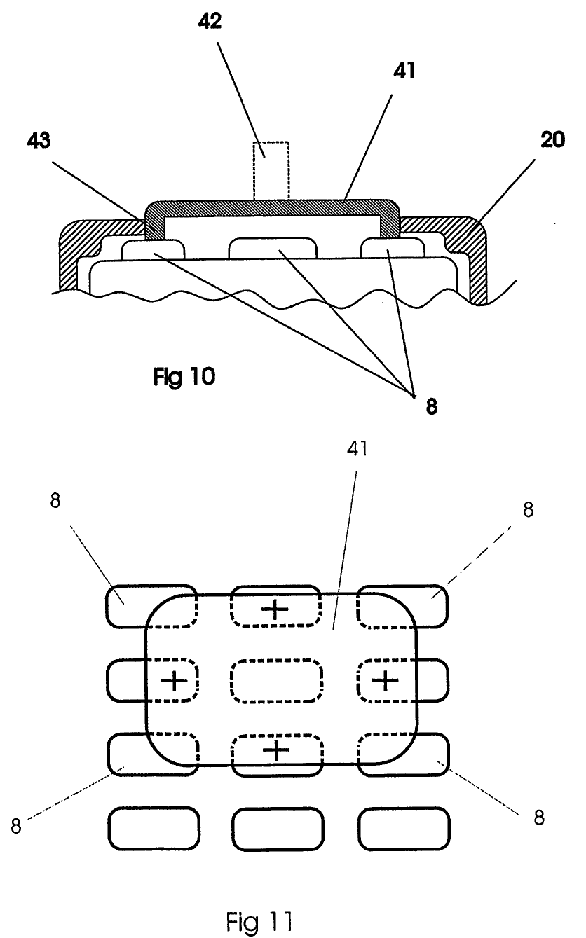

FIGS. 10 and 11 illustrate a four-way key 41 in a casing 20 that acts directly on four keys 8 of the keypad of the phone 1. The four-way key 41 may be provided with a joystick 42, for facilitating cursor/menu navigation and gameplay.

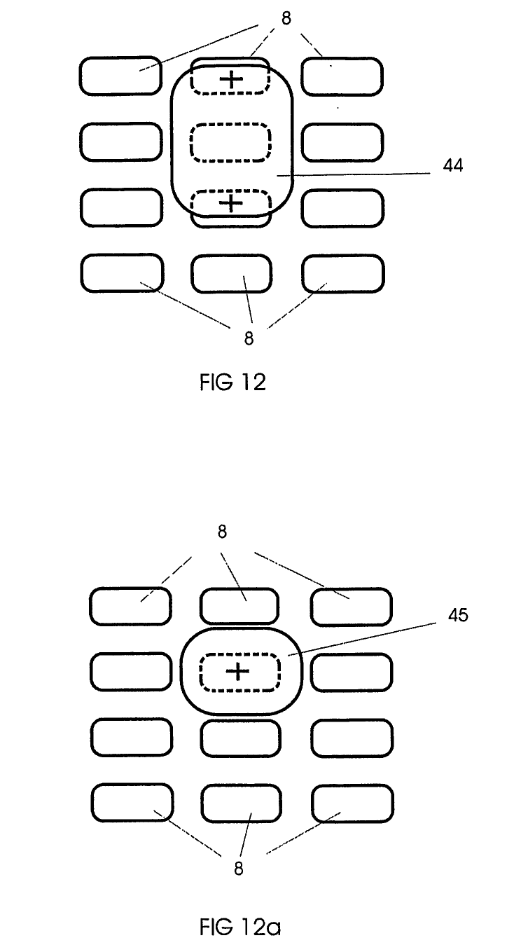

FIG. 12 illustrates a two-way scroll key 44 that is superimposed on the keypad 2 of the phone 1 and acts on two keys 8.

FIG. 12a illustrates a simple button, e.g. an “emergency call” key 44 that is superimposed on the keypad 2 of the phone 1 and acts on one key 8.

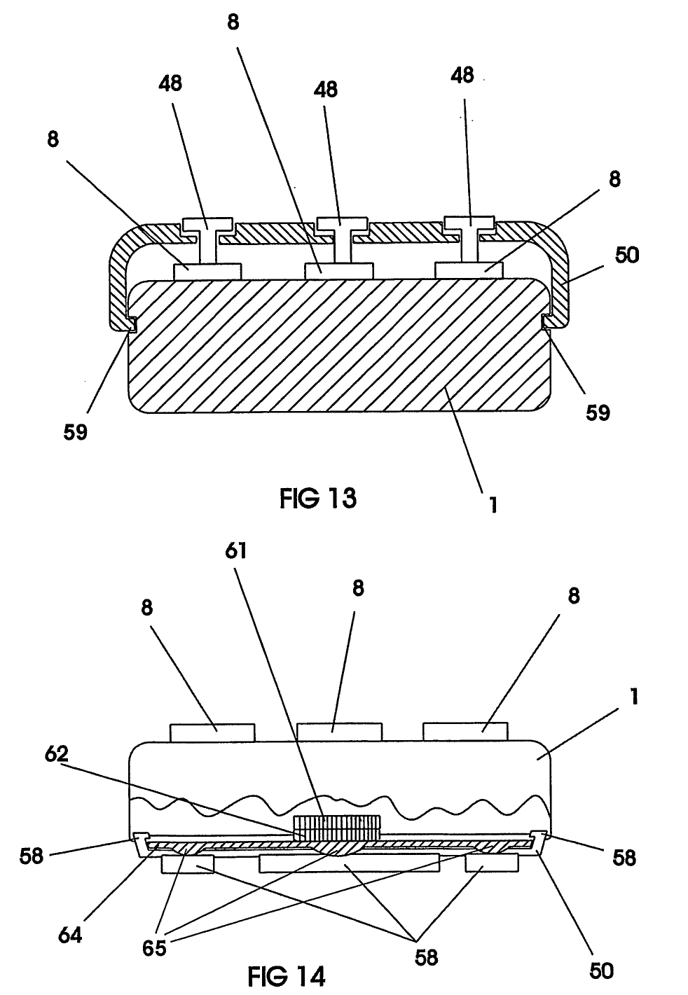

FIG. 13 illustrates a user attachable keypad 50 that is attached to the front of the phone 1 thereby covering the keypad 2 of the phone 1. The user attachable keypad 50 is provided with protrusions 59 that engage corresponding recesses on the sides of the phone 1, thus allowing the user attachable keypad 50 to be attached to the phone 1 by a snap fit connection. The recesses in the phone 1 may be provided with switches that allow the phone 1 to detect that which type of user attachable keypad has been attached. Alternatively, the keypad is provided with protrusions that permanently depress one or more of the keys of the keypad 2 of the phone, thus allowing the phone 1 to detect the type of keypad attached. Upon detection the phone 1 changes its settings as described above for the casings. The material of the keypad is sufficiently resilient to allow it to be removed by the user without difficulty. The keys 48 of the user attachable keypad 50 are superimposed on the keys 8 of the keypad of the phone, and may have a similar construction as the keys described with reference to FIGS. 10,11,12 and 12a.

FIG. 14 illustrates another preferred embodiment of the user attachable keypad 50. The keypad 50 according to this embodiment that is attached to the back of the phone 1. The user attachable keypad is provided with protrusions 58 that can be clicked into corresponding recesses in the back of the phone 1. An electrical connector 61 is also arranged on the back of the phone 1. The electrical connector 61 engages a complementary connector 62 that is provided on the underside of the user attachable keypad 50. The user attachable keypad 50 is provided with a printed circuit board 64 on which the switches 65 for the keys 58 of the user attachable keypad are provided. An electronic keypad identifier (not shown) and the connector 62 are also arranged on printed circuit board 64. When the user attachable keypad 50 is attached to the phone 1 the connectors 61 and 62 engage and the phone 1 is able to detect the type of user attachable keypad that has been attached. Upon detection of the user attachable keypad 50 the phone 1 changes its settings as described above. The user attachable keypad 50 according to this preferred embodiment may comprise a display (not shown), thus giving the phone 1a complete user interface on two sides of the phone 1. If the phone 1 is a swivel phone (not shown), it is not necessary to provide the user attachable keypad 50 with a display since it is possible to reverse the upper part of the swivel phone with the display relative to the lower part with the standard keypad on the one side and the user attachable keypad on the other side, thereby allowing the standard display to be used with both keypads.

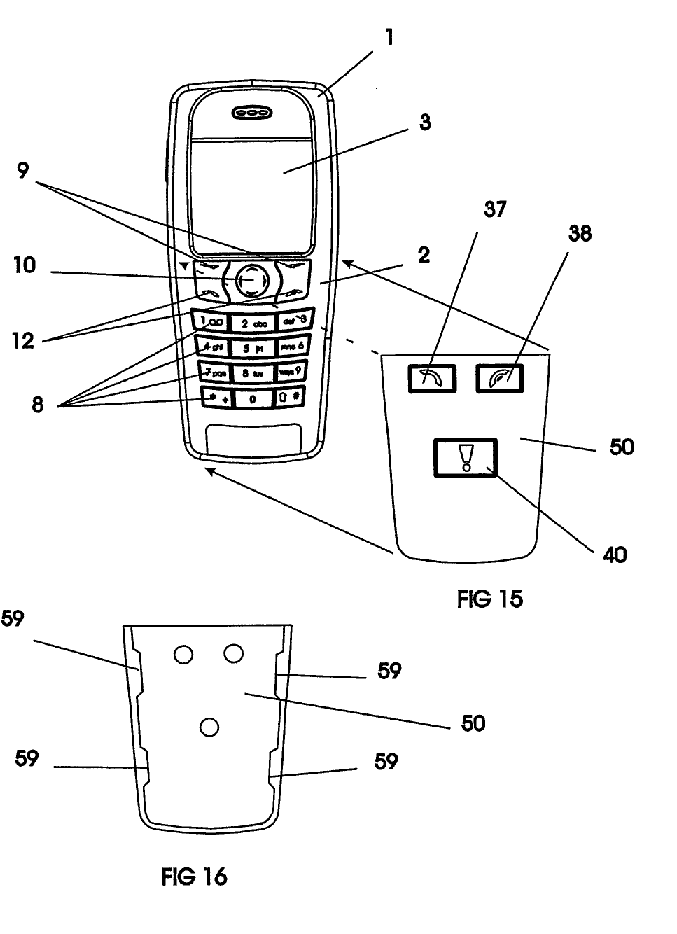

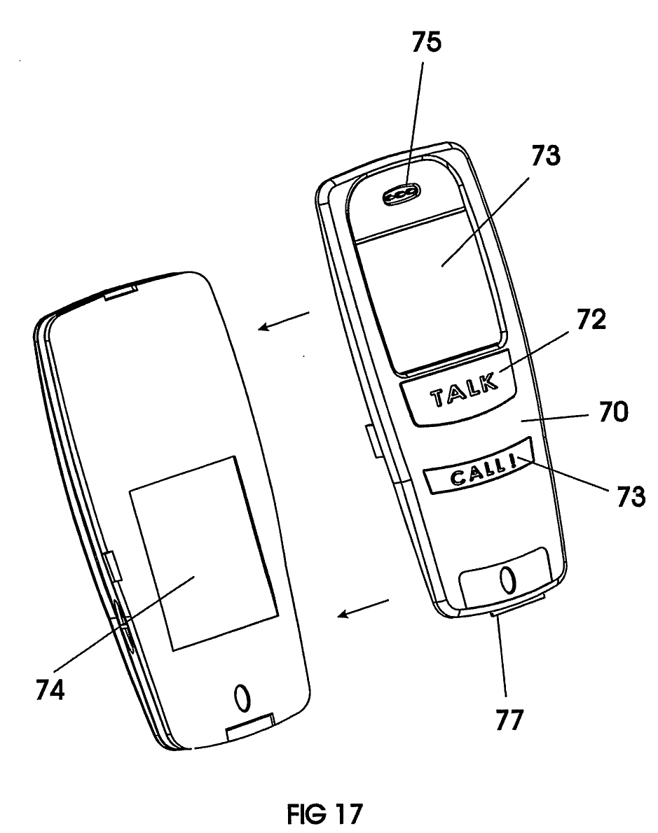

FIGS. 15 and 16 show a user attachable keypad 50 that is very similar to the user attachable keypad described with reference to FIG. 13, the main difference being the key-layout of the user attachable keypad.

FIG. 17 illustrates preferred embodiment of the invention in which the user attachable keypad is integrated in a user attachable rear cover 70. To attach the rear cover 70 the standard releasable cover needs to be removed as shown in FIG. 17. The battery 74 of the phone is now visible and could be changed or taken out to reach the simcard slot (not shown) under the battery. The rear cover 70 comprises the attachment elements that connect to the phone 1 in a releasable manner, as is well known from state of the art releasable covers. The cover 70 comprises a keypad with a push-to-talk key 72 and a call initiation key 73. A loudspeaker 75 (only the openings are shown) and a display 73 are arranged above the key 72. A connector 77 is arranged at the bottom of the user attachable cover. The connector 77 engages a standard connector (not shown) at the bottom of the phone 1, for receiving power and for communication of the display 73, loudspeaker 75 with the processor 18 of the phone 1.

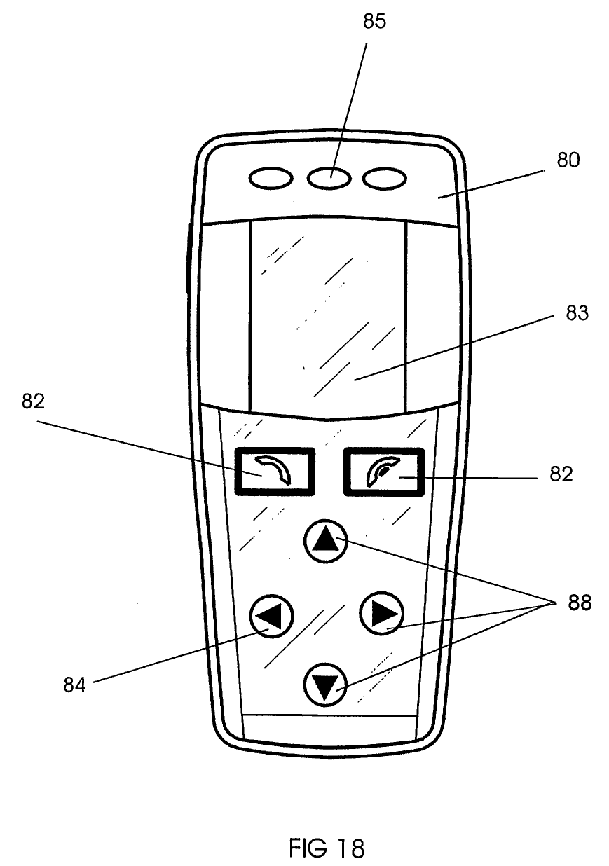

FIG. 18 illustrates a another preferred embodiment of the invention in the form of a softcase 80. The softcase is provided with openings 80 allowing sound of the loudspeaker 5 to leave the softcase, a transparent window part 83 to allow the display 3 to be viewed and a plastic sheet part 84 on which a call answer/initiate key 82, a call end key 82 and arrow keys 88 are printed. The softcase 80 is provided with an RF identification tag (not shown) of a type well known in the art. The RF tag comprises a tag antenna, a tag transceiver, a tag controller and a tag memory and is implemented in a semiconductor chip. An example of a suitable RF tag is a tag manufactured according to the Mifare® Architecture Platform produced by Philips Semiconductors with reference to International Standards Organization (ISO) standard 14443A, parts 2 and 3. The tag transmits a relatively weak identification signal that is picked up by the phone 1 only when the tag is in very close proximity. When the phone 1 is inserted in the softcase 80 it detects the case identification signal and changes its settings accordingly. In a variation of this preferred embodiment the keys of the softcase may be arranged as hard keys on rigid insert in the softcase.

The casings described above can be grip optimized (not shown), e.g. adapted to a specific sports activity or to specific disablements of the user. In order to assist heavily visually impaired users a casing can be provided with a Braille touchpad (not shown).

The casing, the user attachable keypads or the releasable back cover may communicate with the phone 1 via RF, i.e. Bluetooth. The RF connection may be used for identification of the keypad/casing and for transmitting keystrokes to the phone and eventually for sending information to be displayed on the display (if any) of the user attachable keypad/cover. The RF transceiver can be an add-on device that is inserted in a slot in the casing. The casing can be provided with a connector and circuitry that support the use of a loop set in connection with a hearing aid. Alternatively the loop set can be integrated in the casing. Other connectors (not shown), e.g. a jack for a headphone, can also be integrated in the casing. The casing can advantageously be shock and/or water proof/resistant.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the scope of the appended claims.

1. An assembly comprising:
a mobile communication terminal with a keypad, and
a user attachable keypad for releasable attachment to the mobile communication terminal,
an interface between the mobile communication terminal and the user attachable keypad that establishes a connection between the mobile communication terminal and the keys of the removable keypad when the removable keypad is attached to the phone.

2. An assembly according to claim 1, wherein the user attachable keypad is part of a releasable cover that is preferably provided with a window for allowing a display of the mobile communication terminal to be viewed.

3. An assembly according to claim 1, wherein the user attachable keypad is part of a case in which the mobile communication terminal is received, the case preferably being provided with a window for allowing a display of the mobile communication terminal to be viewed.

4. An assembly according to claim 1, wherein the interface is mechanical.

5. An assembly according to claim 4, wherein the keys of the user attachable keypad act on the keys of the mobile communication terminal.

6. An assembly according to claim 5, wherein the user attachable keypad is provided with one or more projections that press down permanently one or more keys of the keypad of the mobile communication terminal when the user attachable keypad is attached to the mobile communication terminal.

7. An assembly according to claim 6, wherein the mobile communication terminal identifies the type of user attachable keypad through the permanently pressed down keys, and changes the settings of the mobile communication terminal in dependence of the type of the identified user attachable keypad.

8. An assembly according to claim 1, wherein the interface is created by an electrical connector.

9. An assembly according to claim 8, wherein the user attachable keypad comprises electronic identification means.

10. An assembly according to claim 9, wherein the mobile communication terminal identifies the user attachable keypad by detecting the electronic identification means, and changes the settings of the mobile communication terminal in dependence of the type of the identified user attachable keypad.

11. An assembly according to claim 8, wherein the connector includes a plurality of connector pins.

12. An assembly according to claim 11, wherein at least one of said connector pins is operated for sensing a resistor value included in the identification means.

13. An assembly according to claim 11, wherein the user attachable keypad comprises one or more integrated circuits or microcontrollers, whereby said identification means and said electric circuitry are preferably incorporated in the one or more integrated circuits or microcontrollers.

14. An assembly according to claim 1, wherein the user releasable cover or user attachable keypad is attached to the mobile communication terminal by a snap fit connection.

15. An assembly according to claim 1, wherein the user attachable keypad comprises a reduced number of keys relative to the keypad of mobile communication terminal.

16. An assembly according to claim 15, wherein the user attachable keypad comprises no more than an on-hook key, an off-hook key and an emergency call key, these keys preferably being relatively large keys compared to the keys of the mobile communication terminal.

17. An assembly according to claim 15, wherein the user attachable keypad comprises no more than an on-hook key, an off-hook key and an emergency call key, these keys preferably being relatively large keys compared to the keys of the mobile communication terminal.

18. An assembly according to claim 15, wherein the user attachable keypad comprises no more than an on-hook key, an off-hook key, ten numeric keys, eventually together with two symbol keys.

19. An assembly according to claim 3, wherein the casing is formed by two hinged shells.

20. An assembly according to claim 3, wherein the casing is formed by two shells that are connected to one another or to the mobile communication terminal by a snap fit connection.

21. An assembly according to claim 14, wherein the font size for text to be displayed on the display is increased when a user attachable keypad is identified.

22. An assembly according to claim 3, wherein the mobile communication terminal comprises a speaker, and the characteristics of the signal delivered to the speaker are adjusted by the mobile communication terminal in accordance with the type of keypad identified, in particular if the keypad is part of a case, said signal characteristics preferably comprising volume and equalizing.

23. An assembly according to claim 1, wherein the user attachable keypad comprises a press-to-talk key.

24. An assembly according to claim 3, wherein the casing comprises a cavity for receiving an extra battery, or other add-on equipment, the cavity is preferably formed by a slot provided with connector means.

25. An assembly according to claim 1, wherein the mobile communication terminal comprises groups of settings in the form of profiles, and wherein the mobile communication terminal changes profile in dependence of the type of user attachable keypad identified.

26. An assembly according to claim 1, wherein the keys of the user attachable keypad are illuminated and preferably arranged in hand optimized positions.

27. An assembly according to claim 1, wherein the user attachable keypad comprises memory means with settings for the mobile communication terminal stored thereon.

28. An assembly according to claim 1, wherein the user attachable keypad or the cover including the user attachable keypad is attached to the front of the mobile communication terminal and the user attachable keypad is superimposed on the keypad of the mobile communication terminal.

29. An assembly according to claim 1, wherein the user attachable keypad or cover is suitable for releasable attachment to the back of the mobile communication terminal, the cover preferably including a display.

30. An assembly according to claim 1, wherein the mobile communication terminal has two housing parts connected by a swivel, the display being arranged on a first of the two housing parts, the keypad being arranged on the front of a second of the two housing parts and the user attachable keypad or cover being attached to the back of the second housing part, whereby the display can be used in combination with both keypads.

31. An assembly according to claim 3, wherein the case is watertight.

32. An assembly according to claim 3, wherein the case provides shock protection for the mobile communication terminal.

33. An assembly according to claim 1, wherein the case is a soft-case.

34. An assembly according to claim 33, wherein the user attachable keypad is formed by a flexible sheet that is superimposed on the keypad, said flexible sheet being provided with labels redefining the function of the keys under the label, and said soft case being provided with identification means allowing the mobile communication terminal to identify the type of soft-case.

35. An assembly according to claim 1, wherein the user attachable keypad is formed by a touch screen.

36. A keypad for user attachment to a mobile communication terminal, the mobile communication terminal has a keypad and the user attachable keypad comprises means for creating an interface with the mobile communication terminal when the user attachable keypad is attached to the mobile communication terminal.

37. A keypad according to claim 36, wherein the user removable keypad is part of a releasable cover that is preferably provided with a window for allowing a display of the mobile communication terminal to be viewed.

38. A keypad according to claim 36, wherein the user removable keypad is part of a case in which the mobile communication terminal is received, the case preferably being provided with a window for allowing a display of the mobile communication terminal to be viewed.

39. A keypad according to claim 36, wherein the interface is mechanical.

40. A keypad according to claim 39, wherein the keys of the removable keypad act on the keys of the mobile communication terminal.

41. A keypad according to claim 40, wherein the user attachable keypad is provided with one or more projections for pressing down permanently one or more keys of the keypad of the mobile communication terminal when the user attachable keypad is attached to the mobile communication terminal.

42. A keypad according to claim 36, wherein the interface is created by an electrical connector.

43. A keypad according to claim 42, wherein the user attachable keypad comprises identification means, the identification means for keypads with a mechanical interface with the mobile communication terminal preferably being one or more projections for pressing down permanently keys of the keypad of the mobile communication terminal.

44. A keypad according to claim 42, wherein the connector includes a plurality of connector pins.

45. A keypad according to claim 44, wherein at least one of said connector pins is operated for sensing a resistor value included in the identification means.

46. A keypad according to claim 45, wherein the user exchangeable keypad comprises one or more integrated circuits or microcontrollers, whereby said identification means and said electric circuitry are preferably incorporated in the one or more integrated circuits or microcontrollers.

47. A keypad according to claim 36, wherein the user releasable cover is provided with snap fit means for attachment to the mobile communication terminal.

48. A keypad according to claim 36, comprising a reduced number of keys relative to the keypad of the mobile communication terminal to be attached to.

49. A keypad according to claim 38, comprising no more than an on-hook key, an off-hook key and an emergency call key, these keys preferably being relatively large keys compared to the keys of the mobile communication terminal.

50. A keypad according to claim 49, comprising no more than an on-hook key, an off-hook key and an emergency call key, these keys preferably being relatively large keys compared to the keys of the mobile communication terminal.

51. A keypad according to claim 50, comprising no more than an on-hook key, an off-hook key, ten numeric keys, eventually together with two symbol keys.

52. A keypad according to claim 38, that is part of a casing formed by two hinged shells.

53. A keypad according to claim 38, that is part of a casing that is formed by two shells that are connected to one another or to the mobile communication terminal by a snap fit.

54. A keypad according to claim 36, comprising a press-to-talk key.

55. A keypad according to claim 38, wherein the casing comprises an extra battery.

56. A keypad according to claim 36, wherein the keys are illuminated and preferably arranged in hand optimized positions.

57. A keypad according to claim 36, comprising memory means with settings for a mobile communication terminal to be connected to stored thereon.

58. A keypad according to claim 36, wherein the cover comprises a display.

59. A mobile communication terminal comprising a keypad and means for adjusting the settings of the mobile communication terminal when a user releasable keypad is attached to the mobile communication terminal.

60. A mobile communication terminal according to claim 59, that identifies the type of user attachable keypad attached to it through permanently pressed down keys, and changes the settings of the mobile communication terminal in dependence of the type of the identified user attachable keypad.

61. A mobile communication terminal according to claim 59, wherein the mobile communication terminal identifies a user attachable keypad by detecting an identification means in the latter, and changes the settings of the mobile communication terminal in dependence of the type of the identified user attachable keypad.

62. A mobile communication terminal according to claim 59, wherein the mobile communication terminal comprises groups of settings in the form of profiles, and wherein the mobile communication terminal changes profile in dependence of the type of user attachable keypad identified.

63. A mobile communication terminal according to claim 61, wherein the font size for text to be displayed on the display is increased when a user attachable keypad is identified.

64. A mobile communication terminal according to claim 59 wherein the mobile communication terminal comprises a speaker, and the characteristics of the signal delivered to the speaker are adjusted by the mobile communication terminal in accordance with the type of user attachable keypad identified, in particular if the user attachable keypad is part of a casing, said signal characteristics preferably comprising loudness and equalizing.
